(19) United States
(12) Patent Application Publication
(10) Pub. No.: US 2004/0053693 A1
(43) Pub. Date: Mar. 18, 2004

(54) Method and apparatus for exact calculation of gambling game fee

(76) Inventor: Gi Ju An, Jeonju-city (KR)

Correspondence Address: JONES DAY, 222 EAST 41ST STREET, NEW YORK, NY, 10017, US

(21) Appl. No.: 10/451,228

(22) PCT Filed: Jul. 31, 2001
(86) PCT No.: PCT/KR01/01301

(30) Foreign Application Priority Data
Dec. 19, 2000 (KR) 2000/78213

(51) Int. Cl. A63F 13/00; G06F 17/00

(52) U.S. Cl. 463/40

(57) ABSTRACT

The method for calculating a game fee depending on victory or defeat of a user in a gambling game played through at least two client PCs connected in one or more networks in which a plurality of client PCs are connected to one management server computer, includes the steps of opening a real account and a corresponding virtual account, processing game among gamers, calculating a game fee depending on victory or defeat of each gamer, transferring money from a virtual account of winner to a virtual account of loser, checking a breakdown of the real account with the balance of the virtual account, and instructing money transfer between the real accounts based on the breakdown.

### TECHNICAL FIELD

The present invention relates to a method of playing a game through a network, and more particularly to a method of imposing differential gambling game fees depending on victory or defeat of the gambling game between at least two client PCs (personal computers) in the circumstance that a plurality of client PCs are connected to the same or different networks.

### BACKGROUND ART

Together with development of various computer and network techniques, computer games are activated for various age groups owing to diversification of game software.

Particularly, with popularizing of computing environments such as Internet game room (or, Internet cafe) in which a plurality of client computers are connected to one management server computer through a local network, the network game is more activated (hereinafter, the place providing such computing environments for network games is referred to as “Internet Café”), thus the game industry is developed more and more. However, there is recognized a limit for the Internet Cafe to attract gamers because of lack improvement of Internet Cafe managing manners.

The conventional Internet Cafe management adopts charging the same rental fee regardless of the gamers' position. Thus, the gamers have frequently played a game heartlessly, conscious of proceeding time rather than win/lose of the game. Even in a game providing a chatting service together, there are occasionally rampant abuse words, so deteriorating the quality of game.

On the other hand, people tend to enjoy gambling games rather than other games. However, since there is not yet provided a suitable solution, it is inconveniently uneasy for gamers who are long way off, not in the same Internet Café, to enjoy the gambling game.

Korean Patent Application No.2000-21751 discloses apparatus and method for transferring mileage points different depending on game results, at an Internet Café management system including a plurality of Internet Cafés having a plurality of computers and at least one manager computer, the Internet Café management system being connected to the Internet Cafés for data transmission and having a central computer used as a data center. According to the above document, if at least two members request to bet on a game, the manager computer checks whether the members agree to the game, creates a game purse by using a mileage point of each member stored in the central computer, and then arranges the game purses depending on game results to transfer a mileage point to a winner of the game.

However, this prior art cannot achieve a true purpose of gambling since the compensation according to the game results is solved with a virtual mileage point. In addition, because each game bets a certain point to the game purse, it may produce harmful side effects of stirring up a speculative spirit.

Thus, the inventor of the present invention has been filed a Korean Patent No.2000-78213 (which is a basis of domestic priority of another application), disclosing a new gambling game method in which a loser of a gambling game takes a charge of a game fee of a winner and pays the fee to an Internet Café, instead of the conventional gambling game based on a betting manner of a mileage point.

The present invention is more improved and developed from the application and adopts a method of settling a game fee with use of a virtual account of Internet Café and an actual account corresponding to the virtual account in order to impose differential game fees on winner and loser.

### DISCLOSURE OF INVENTION

The present invention is designed to overcome problems of the prior art, and an object of the present invention is to provide a method of progressing a gambling game between different Internet café, and imposing a game fee of a winner on a loser depending on win/lose of the game so that the loser pays the game fee of the winner.

Another object of the present invention is to provide a method of automatically settling unfair game fee profits caused in Internet Cafés according to win/lose of gamers belonging to the Internet Café.

In order to accomplish the above object, the present invention provides a method of exact calculation of gambling game fee under the network environment in which a plurality of gamer terminals are connected through a local network to a first server computer, a plurality of the first server computers are connected to a second server computer, and the second server computer is connected to a banking computer, which possesses actual accounts of service providers managing the local network and is capable of transferring money between the actual accounts on-line, the method including (a) opening actual accounts of a plurality of the service providers with the banking server and creating a virtual account corresponding to the actual account with the second server computer; (b) at least two gamer inputting requests for gambling at a specific game into the second server computer; (c) allowing at least two gamers to compete each other in the specific game, deciding winner and loser of the game when the game ends, and then calculating a game fee based on hours that the game has proceeded; (d) drawing money corresponding to the game fee from a virtual account of a service provider of the local network used by the winner and then transferring the money to a virtual account of a service provider of the local network used by the loser; (e) investigating the balances of all virtual accounts when it comes to the time of settlement to calculate money transfer details corresponding to each actual account; and (f) instructing the banking computer to transfer money between the actual accounts based on the money transfer details.

Preferably, the present invention may include the step of checking the service provider of the local network used by the gamer and the virtual account of the corresponding service provider on the basis of location information of the gamer terminal requesting the gambling game.

The present invention may also additionally include the steps of transmitting game win/lose information, proceeded game hour information and game fee information to the first server of the local network used by the winner and the loser; and calculating rental fees of the local network and each gamer terminal belonging to the local network on the basis of the game win/lose information, the proceeded game hour information and the game fee information.

Preferably, a total fee of the winner is calculated by subtracting the game fee from the rental fee, while a final fee of the loser is calculated by adding the game fee to the rental fee.

In addition, it is preferred that the virtual account initially has a zero balance, the balance becomes minus when money is transferred to another virtual account, and the balance is reset to zero after the time of settlement.

In the (vi) step, the money transfer details of the actual account can be created based on the virtual account, thereby, if the balance of the virtual account is plus at the time of settlement, instructing the back computer to draw an amount of money, equal to the plus amount, from the corresponding actual account to be distributably transferred to at least one other actual account, while, if the balance of the virtual account is minus at the time of settlement, instructing the bank computer to distributably draw an amount of money, equal to the minus amount, from at least one other actual account to be received to the corresponding actual account.

In addition, the present invention may further include the steps of searching the balances of the actual accounts for all service providers in the banking computer; comparing the searched balances with a standard balance; and outputting an electronic notification note for notifying the server computer of the service provider, whose the actual account has a balance less than the standard balance, to deposit money as much as the difference with the standard balance in the actual account.

The present invention may additionally include the steps of extracting an actual account having a balance less than the standard balance after a term of the electronic notification note; and interrupting the gambling game service of a gamer terminal connected to a local network of the service provider corresponding the extracted account.

At this time, it is preferred that the actual account is capable of having minus balance up to a predetermined limit.

According to another preferred embodiment of the present invention, there is provided an apparatus for arranging a gambling game between at least two gamer and settling gambling game fees depending on win or lose of the gambling game under the network environment in which a plurality of gamer terminals are connected through a local network to a first server computer, a plurality of the first server computers are connected to a second server computer, and the second server computer is connected to a banking computer, which possesses actual accounts of service providers managing the local network and is capable of transferring money between the actual accounts on-line, the apparatus including a storage unit; and a processing unit connected to the storage unit, in which the storage unit stores program to control the processing unit, and in which the processing unit performs creating a virtual account corresponding to each actual account of a plurality of service providers opened with the banking server; receiving requests for gambling at a specific game from at least two gamer; allowing at least two gamers to compete each other in the specific game, deciding winner and loser of the game when the game ends, and then calculating a game fee based on hours that the game has progressed; drawing money corresponding to the game fee from a virtual account of a service provider of the local network used by the winner and then transferring the money to a virtual account of a service provider of the local network used by the loser; investigating the balances of all virtual accounts when it comes to the time of settlement to calculate money transfer details corresponding to each actual account; and instructing the banking computer to transfer money between the actual accounts based on the money transfer details.

In addition, the processing unit preferably checks the service provider of the local network used by the gamer and the virtual account of the corresponding service provider on the basis of location information of the gamer terminal requesting the gambling game.

Preferably, the processing unit transmits game win/lose information, proceeded game hour information and game fee information to the first server of the local network used by the winner and the loser, and calculates rental fees of the local network and each gamer terminal belonging to the local network on the basis of the game win/lose information, the proceeded game hour information and the game fee information.

The processing unit may, either if the balance of the virtual account is plus at the time of settlement, instruct the back computer to draw an amount of money, equal to the plus amount, from the corresponding actual account to be distributably transferred to at least one other actual account, or if the balance of the virtual account is minus at the time of settlement, instruct the bank computer to distributably draw an amount of money, equal to the minus amount, from at least one other actual account to be received to the corresponding actual account.

### BRIEF DESCRIPTION OF THE DRAWINGS

### BEST MODES FOR CARRYING OUT THE INVENTION

Hereinafter, preferred embodiments of the present invention will be described in detail with reference to the attached drawings.

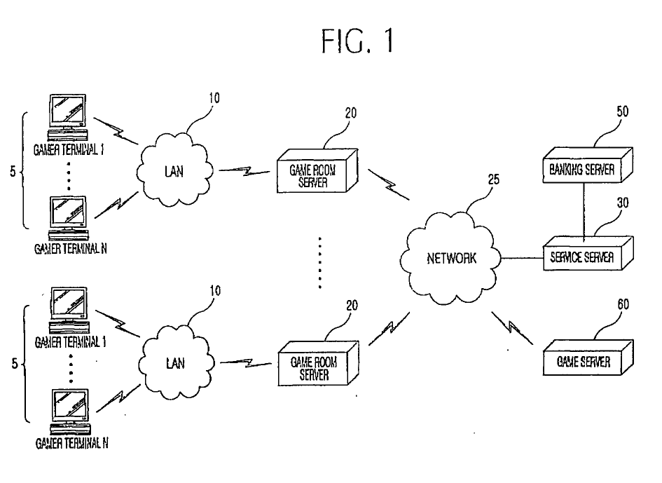

FIG. 1 shows system configuration for realizing a method of imposing differential gambling game fees depending on victory or defeat of the gambling game. As shown in the figure, the system adopted in the present invention preferably includes a Internet Café server 20 for managing at least one gamer terminal 5 through LAN, a service server 30 for allowing a gambling game among gamers on network 25 and imposing and settling game fees based on a gambling result, a game server 60 for providing game contents and game programs, and a banking server 50 connected to the service server 30 for automatic account-to-account money transfer between Internet Cafés.

The gamer terminal 5 is a personal computer connected to the Internet Café server 20 through a local network 10. This gamer terminal 5 includes a communication module for data transmission, operating system and web browser. And, the gamer terminal 5 sends data such as proceeded game hour, required for management of the Internet Café, to the Internet Café server 20 by command of a management program in the Internet Café server 20.

The Internet Café server 20 is a computer system for managing a plurality of gamer terminals 5 connected to a local network. The Internet Café server 20 includes means for mutually interfacing the gamer terminals with the service server, and a program for exactly calculating final fees of a gamer on the basis of proceeded game hour, game win/lose, game fee, etc. transmitted from the service server.

The computing environment in which the Internet Café server is connected through a local network to a plurality of gamer terminals is not limited to an Internet game room (or, Internet café), but should be understood to include all network environments in which a plurality of client terminals are connected to one server computer so as to enjoy gambling games with other remote client terminals.

The network 25 generally means Internet. But, not limited to Internet, it should be understood that the network 25 means including Intranet, Extranet and Dedicated line.

The banking server 50 can be a server computer existing in a banking agency (particularly, a bank), or it is also possible for a provider of the service server (or, a service provider) to separately install the banking server 50. This banking server 50 manages actual accounts of a plurality of Internet Cafés in concert with the service provider by franchise. The banking server also has a program module for automatically transferring money between actual accounts according to a command from a manager of the Internet Café as well as a server of the service provider. Such a banking server is well known to a person skilled in the art, and not described in detail.

The game server 60 is a computer system, which has a plurality of game programs and allocates a communication port to a client terminal by request of the service server so that a specific game program may be enjoyed in the designated client terminal. Though FIG. 1 shows that only one game server contains many game programs, it is also possible that there are many game servers to support one game program in connection with the service server through a network.

The service server 30 is a computer system, which allows gamers, accessed through each Internet Café, to compete each other in a specific gambling game, transmits game fee information based on win/lose of the gambling game to the Internet Café server and manages virtual accounts corresponding to the actual account in the banking server for transfer and settlement of fees.

This service server 30 is a large capacity computer system equipped with central processing unit, RAM, ROM, network interface, data storage unit and so on. A traditional personal computer or a workstation having a memory with a significant storage and considerable processing capacity can be used as the service server. As an example, the service server acts as a web server for data transmission in order that games may enjoy gambling game.

The service server may have great processing ability, so enabling to execute an immense amount of mathematical calculation in information processing or database searching. Pentium Microprocessor manufactured by Intel can be mainly used as a central processing unit.

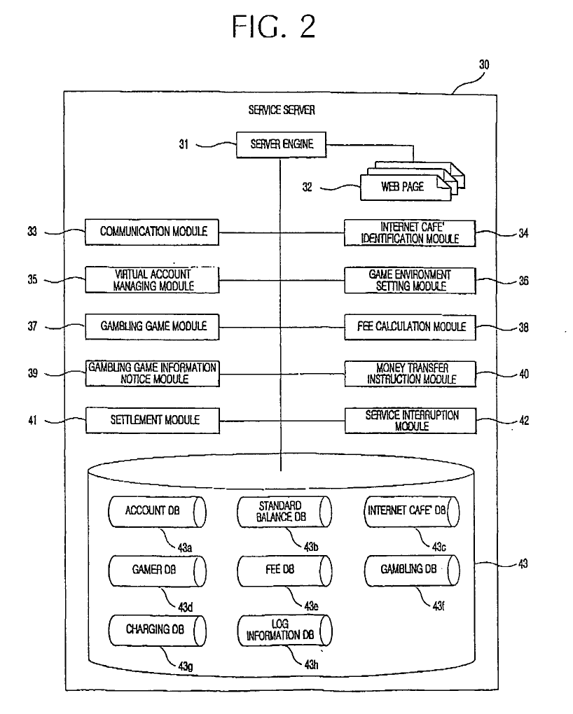

FIG. 2 shows program modules loaded in ROM of the service server and a plurality of databases constituting the data storage unit.

The service server 30 is not described in detail.

The service server 30 is composed with program modules including a server engine 31, a communication module 33 for data transmission, a Internet Café identification module 34, a virtual account managing module 35, a game environment setting module 36, a gambling game module 37, a fee calculation module 38, a gambling game information notice module 39, a money transfer instruction module 40, a settlement module 41 and a service interruption module 42, and a database system including an account DB 43a, a standard balance DB 43b, a Internet Café DB 43c, a gamer DB 43d, a fee DB 43e, a gambling DB 43f, a charging DB 43g and a log information DB 43h.

The server engine 31 is in charge of system operation. Particularly, the server engine 31 is a firmware program for providing web pages 32 to client systems such as the gamer terminals 5 or the Internet Café server 20 in request of HTTP (Hyper Text Transfer Protocol) for the purpose of accessing the web page 32 recognized by URL (Uniform Resource Locator).

The Internet Café server identification module 34 is a program module to identify a belonging Internet Café on the basis of location information of the connected gamer terminal 5. In other words, if a specific gamer terminal 5 connects to the service server 30, the Internet Café server identification module 34 of the service server finds out an IP address of the corresponding gamer terminal 4 and then discriminates the Internet Café (or a member store), to which the client terminal having the IP address belongs, by searching the Internet Café DB 43c described later.

The virtual account managing module 35 is a program module for creating a virtual account corresponding to each actual account existing in the banking server 50, transferring money between the virtual accounts according to win/lose results of the gambling game, and automatically resetting a balance to zero at the time of settlement.

The game environment setting module 36 is a program module for allowing gamers, who desire a gambling game, to compete each other, setting a gambling game room (or, gambling game software) for the gamers to enjoy the game with opponent(s), and allocating a communication port to the game server for the corresponding gambling game room.

The gambling game module 37 is a program module for detecting an end of the game, which has been progressed in the gambling game room, determining winner and loser after the game is over, and calculating a game fee on the basis of proceeded hours of the gambling game.

The fee calculation module 38 is a program module for checking whether it comes to the time of settlement, extracting money transfer details between the virtual accounts of the Internet Cafés at the time of settlement, and transmitting the money transfer details to the money transfer instruction module 40 described below.

The gambling game information notice module 40 is a program module for searching the gambling DB 43f and the fee DB 43e to extract game win/lose information, proceeded game hour information, game fee information and gamer information when a specific gambling game is over, and then transmitting such information to the Internet Café server 20.

The money transfer instruction module 40 is a program module for receiving the money transfer details between the virtual accounts from the fee calculation module 38 and instructing the banking server 50 to transfer money between the actual accounts. In other words, though there are needed ID and password to draw or transfer a certain amount of money from an actual account with the banking server as a rule, the present invention additionally endows specific ID and password to a service provider so that the service provider may freely transfer money between the actual accounts of the affiliated Internet Cafés.

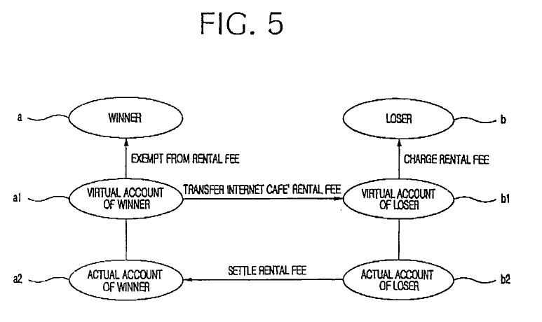

The settlement module 41 is a program module for executing the settlement process shown in FIG. 5. In other words, this settlement module 41 extracts delinquent Internet Cafés by inquiring a balance of the actual account of each Internet Café, and providing delinquent Internet Café information to the service interruption module 42 described below.

The service interruption module 42 is a program module for interrupting a gamer to access the service server through a specific Internet Café.

The account DB 43a stores and manages virtual accounts of respective Internet Cafés, actual accounts corresponding to respective virtual accounts, depositors, peculiar Ids required for Internet banking, passwords required for money transfer and so on. Preferably, the virtual account has an initial balance of zero, which balance becomes plus or minus when money is deposited or drawn through money transfer between virtual accounts, and which balance is reset to zero after settlement.

Additionally, the actual account existing in the banking server 50 is preferably capable of having minus balance, which is allowed to a manager of each Internet Café by a banking agency managing the banking server based on security stood by a service provider through agreements among the banking agency, the service provider and the Internet Café manager. The actual account has not to be capable of having a minus balance in the present invention, of course. The actual account should be understood to include all kinds of bank products capable of freely transferring money at a regular period on line, if it does not cause any problem to realize of the present invention.

In addition, it is preferably that the service provider affiliates with the Internet Café managers by, for example, franchising with the object of providing the gambling game service.

The standard balance DB 43b stores and manages information related to the lowest limit of balance for actual accounts, which should be basically observed by each Internet Café manager for smoothly progressing the gambling game. This standard balance information can be changed depending on agreements between the service provider and the Internet Café.

The Internet Café DB 43c stores and manages all information related to Internet Cafés, Internet Café managers, Internet Café servers and personal computers connected to each Internet Café server through a local network. Such information includes names of Internet Cafés, personal information of Internet Café managers, IP addresses of Internet Café servers and IP addresses of personal computers in each Internet Café.

The gamer DB 43d stores and manages gamer information such as resident registration number, address, name etc. of gamers participating in a gambling game, certification/identification information such as ID and password endowed for use of service, gamer history information such as gambling game history (for example, 1 win & 2 loses in Lineage, 3 wins in Fortress, 3 loses in Starcraft), ability level of a gamer (for example, 1^{st} class in Lineage, 3^{rd} class in Fortress) and so on.

The charging DB 43g stores a table related to game fees for proceeded hours of a specific game. For example, the charging DB 43g stores the game fee information for each proceeded game hour as follows: 20 won per minute is charged for Starcraft, 15 won per minute is charged for Lineage.

The fee DB 43e stores and manages a proceeded hour of a specific gambling game, game win/lose information, a fee of a winner, a fee of a loser and so on.

The gambling DB 43f stores and manages a title of a gambling game, identification information of participated gamers, a game start time, a game end time, game win/lose information an so on.

The log information DB 43g stores and manages log files created whenever a gamer terminal accesses the service server. This log file is composed of data fields such as an access location, an IP address of an accessed terminal, an access time and an access path.

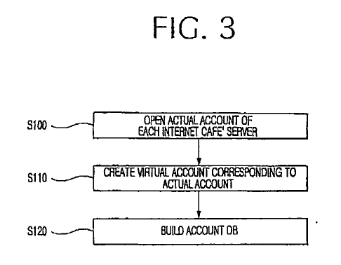

Now, the processes of imposing differential fees at Internet Cafés depending on win/lose of a game according to the present invention, implemented by the system described above, are described with reference to FIGS. 3 to 6.

First, the process of creating a virtual account and an actual account, executed as a pre-process before the gambling game progresss, is explained with reference to FIG. 3.

The service provider and the Internet Café manager conclude cooperation agreements required for the gambling game service (which is possible either on-line or off-line) and open an actual account (for example, capable of having minus balance) for the Internet Café agreed with the cooperation agreements (S100).

If an actual account is opened with the banking server, the virtual account managing module 35 creates a virtual account corresponding to the actual account (S110), and then builds the account DB 43a with an account number of the actual account, an ID for Internet banking and a password for money transfer (S120).

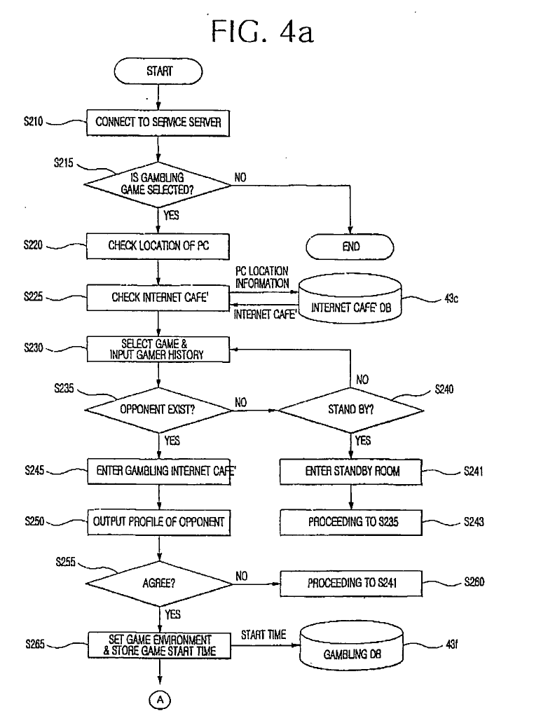

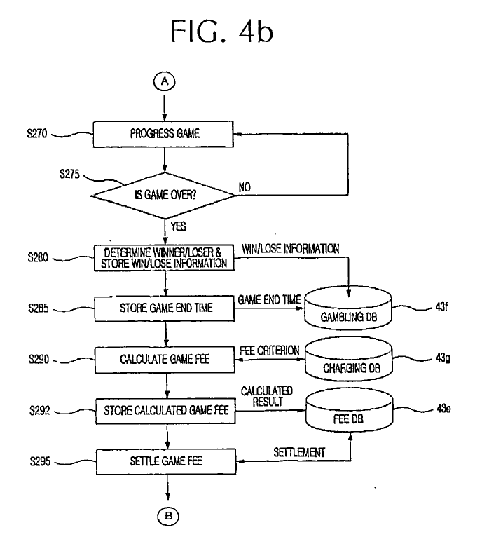

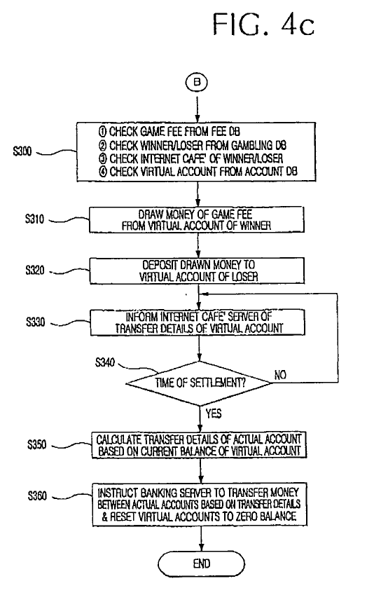

Now, the process of setting game environments of the gambling game is described in detail with reference to FIG. 4a.

After completing the pre-process for progressing the gambling game, if a gamer, belonging to a specific Internet Café, accesses the service server 30 through a personal computer (S210), the service server 30 outputs a web page containing a gambling game selection menu to a corresponding client system 5.

At this time, the gamer inputs a gambling game request command by clicking the gambling game selection menu displayed on a browser screen (S215).

The steps (S210-S215) can also be realized by selecting a specific icon existing on an OS screen of the client system.

If the gamer selects a gambling game as described above, the Internet Café server identification module 34 accesses the log information DB 43h to analyze a log file related to the accessed client system and check location information of the accessed PC (S220).

By searching the Internet Café DB 43c based on this location information, the Internet Café to which the client system is belonging can be checked (S225).

After checking the Internet Café to which the gamer belongs, the service server outputs to the client system a web page for the gamer to select a desired game and input his/her history. At this time, the gamer selects a desired one among possible gambling games and inputs personal information, gambling game history and ability level of the selected game (S230).

If building a separate member DB and operating the service in the membership system, the step S230 can be curtained into just inputting ID and password.

If the gamer selects a desired gambling game, the game environment setting module 36 of the service server searches the gamer DB 43d to determine whether there exists any opponent to compete with the gamer (S235). If there is no opponent, the service server inquires of the gamer whether or not to stand by until an opponent appears (S240).

If the gamer chooses to wait for appearance of an opponent, the game environment setting module 36 admits the corresponding gamer to enter a waiting room (S241). In this waiting room, various contents such as chatting, e-mail and electronic commerce are provided so that the gamer may spend useful time while standing by. After the gamer enters the waiting room, the game environment setting module 36 returns to the step S235 to keep searching another opponent (S243).

On the other hand, if the gamer refuses to enter the waiting room in the step S240, the game environment setting module 36 guides the gamer to the step S230 to select another game.

Meanwhile, if there is an opponent(s) in the step S235, the game environment setting module 36 admits the gamer and the opponent to enter the gambling game room (S245).

If at least two gamers enter the gambling game room, the game environment setting module 36 outputs a profile of the opponent on a browser screen of each gamer (S250). This profile includes records such as win/lose information of the corresponding gambling game and an objective ability level for the corresponding gambling game.

After checking the profile of the opponent, each gamer is asked whether to progress the gambling game (S255). If any of the gamers disagrees, each gamer returns to the step S241 to enter the waiting room (S260).

Or, if all gamers agree to join the gambling game in the step S255, the game environment setting module 36 enables the gamers to enjoy the gambling game by allocating a communication port to the game server 60 and builds a gambling game platform for gamers. If the gambling game platform is built, the game environment setting module 36 records a game start time in the gambling DB 43f (S265).

The term “gambling” means not only one-to-one competing game but also all kinds of games, which can classify the gamers into winner and loser regardless of the number of gamers.

Now, the process of progressing the gambling game and the process of calculating a game fee are described with reference to FIG. 4b.

If the gambling game environments are set and the game is progressed among garners (S270), the gambling game module 37 keeps checking whether the game ends or not from the game server 60 (S275).

If checking that the game is over, the gambling game module 37 receives win/lose results from the game server 60, classifies the garners into winner and loser based on the win/lose results and stores the fact in the gambling DB 43f (S280).

Additionally, the gambling game module 37 stores the time that the time that the game ends, or a game end time, in the gambling DB 43f (S285).

With the game end time and the game win/lose information store, the gambling game module 37 calculates proceeded game hours from the game start time and the game end time, then calculates a game fee corresponding to the proceeded game hours by searching the charging DB 43g (S290).

Such a calculated game fee is recorded in the fee DB 43e (S292), and then the game fee settlement process is executed (S290).

Now, the process of settling a game fee is described in detail with reference to FIG. 4e.

The fee calculation module 38 of the service server accesses the fee DB 43e to check a game fee for a corresponding gambling game, extracts information related to winner and loser from the gambling DB 43f, checks Internet Cafés to which the winner and the loser are belonging by searching the Internet Café DB 43c, and then checks a virtual account number of each belonging Internet Café from the account DB 43a (S300).

If information required for fee settlement is extracted, the fee calculation module 38 draws money as much as the game fee from the virtual account of the winner in the account DB 43a (S310).

The money drawn from the virtual account of the winner is then deposited in the virtual account of the loser by the fee calculation module 38 (S320).

If the money is transferred between the virtual accounts as described above, the gambling game information notice module 39 informs the Internet Cafés, to which the winner and the loser are belonging, of information such as money transfer details, game win/lose information, proceeded game hours, game fee and so on (S330).

The Internet Café server informed of information such as game fee related to a gambling game then calculates a total fee of each corresponding gamer on the basis of a gambling game fee information. Thus, the winner is exempted from the game fee among a rental fee (including the game fee), while the loser should pay to the Internet Café a charge in which the game fee of the winner is added to a rental fee. The rental fee means a fee charged for using a personal computer belonging to a Internet Café, added to the game fee.

As an example for better understanding, assuming that a game fee of a gambling game is 1,000 won, a rental fee (including the game fee) of a winner of the gambling game is 3,000 won and a rental fee (including the game fee) of a loser of the gambling game is 2,500 won, the winner just pays 2,000 won as a total fee, which is an amount subtracting the gambling game fee 1,000 won from his/her rental fee, and the loser should pay 3,500 won as a total fee, which is an amount adding the gambling game fee 1,000 won of the winner to his/her rental fee.

Thus, the Internet Café to which the winner belongs suffers a loss of 1,000 won and the Internet Café to which the loser belongs gains 1,000 won, unfairly.

To solve such a problem, the process of settling fees is performed through the steps S350-S360.

If the money transfer between virtual accounts is completed, the fee calculation module 38 checks whether it comes to the time of settlement for actual accounts (S340).

At this time, the time of settlement can performed at a specific time a day, one time a week, one time a month etc.

If it comes to the time of settlement in the step S340, the fee calculation module 38 calculates money transfer details in actual accounts on the basis of current balances of all virtual accounts in the account DB 43a (S350).

For example, assuming that a balance of a virtual account A is −1,000 won, a balance of a virtual account B is −300 won, a balance of a virtual account C is +500 won, a balance of a virtual account D is +800 won and a balance of a virtual account E is zero, it is required to transfer 300 won from an actual account D corresponding to the virtual account to an actual account B, transfer 500 won from an actual account C to an actual account A, and transfer 500 won from an actual account D to an actual account A.

In other words, since an initial balance of a virtual account is zero, minus balance of a virtual account means that there are relatively more winners among gamers belonging to a Internet Café corresponding to the virtual account and thus the Internet Café suffers a loss in the rental fees. Similarly, plus balance means that there are relatively more losers among gamers, thus the corresponding Internet Café gains more profit in the rental fees.

Therefore, the money as much as unfair profit is drawn from the actual account of the Internet Café, which gains the unfair profit, and then transferred to the actual account of the Internet Café, which suffers the unfair loss, thus preventing managers of the Internet Cafés from unfairly losing money due to the gambling game.

If the actual account is capable of having a minus balance, the unfair profit can be retrieved rapidly with changing a balance of an actual account of a Internet Café gaining the unfair profit into minus.

If the money transfer details for the actual accounts are calculated in the step S350, these money transfer details are temporarily stored and the money transfer instruction module 40 instructs the banking server 59 to transfer money between the actual accounts and resets balances of all virtual accounts to zero (S360).

The money transfer of the actual accounts conducted by the money transfer instruction module 40 is performed based on the IDs for Internet banking and the passwords for money transfer of each depositor existing in the account DB 43a.

Through the process routine through FIGS. 3 to 4c, a gamer visits a specific Internet Café and enjoys a gambling game as usual. Then, the gamer is exempted from a gambling game fee when winning the game, while in charge of additional game fee of a winner when losing the game. Thus, the gamers may have a feeling as if he/she plays a game at the risk of his/her own money.

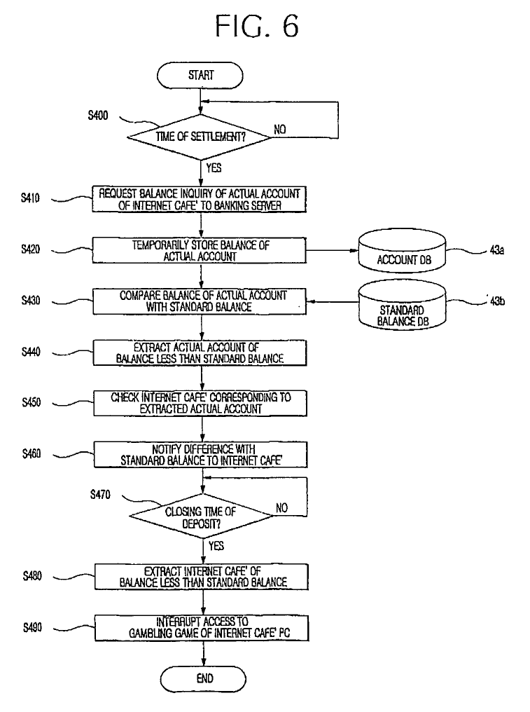

However, a Internet Café to which a winner is belonging suffers a loss because of obtaining less money than a rental fee (including the game fee), while a Internet Café to which a loser is belonging gains more money because of obtaining more money than a rental fee (including the game fee). Thus, the present invention solves the unfair transactions by money transfer between the virtual accounts and settlement between the actual accounts based on the balances of the virtual accounts, as shown in FIG. 6.

On the other hand, the present invention adopts a settlement procedure as shown in FIG. 5 to smoothly settle the actual accounts of the Internet Café servers.

In other words, the settlement module 41 determines whether it comes to the time of settlement (S400). If it comes to the time of settlement, the settlement module 41 requests the banking server 50 to inquire a balance of an actual account for each Internet Café server 30 (S410), and then stores in the account DB 43a the actual account balance information transmitted from the banking servers 50 (S420). After that, the settlement module 41 compares the actual account balances with the standard balance data stored in the standard balance DB 43b (S430), extracts an actual account(s) having a balance less than the standard balance (S440), and then checks a Internet Café corresponding to the extracted actual account from the account DB 43a (S450).

After checking the Internet Café information, the settlement module 41 performs a procedure of notifying the corresponding Internet Café to deposit the difference between the balance of the actual account and the standard balance (S460). Then, the settlement module 41 checks whether it comes to a closing time of deposit (S470). If it comes to the closing time of deposit, the settlement module 41 extracts a Internet Café(s) having a balance less than the standard balance again (S480). If there is any Internet Café having insufficient balance, the service interruption module 42 prohibits PCs in the corresponding Internet Café from accessing the gambling games related to the service of the present invention. At this time, an arrearage charge can be imposed on the Internet Café depending on days in arrears, of course.

The present invention materializes the service so that a loser bears the game fee of a winner through the processes described above. FIG. 6 schematically shows the process of imposing and settling game fees depending on win/lose of the game. As shown in the figure, if the game is over, a game fee is transferred from a virtual account (a1) of a winner-side Internet Café server to a virtual account (b1) of a loser-side Internet Café server. Thus, the winner (a) is exempted from the game fee since there is no game fee to be charged, while the loser (b) should bear the game fee of the winner as well as his/her own game fee. In addition, money corresponding to the money transfer details is transferred from an actual account (b2) of the loser-side Internet Café server to an actual account (a2) of the winner-side Internet Café server, so settling the actual accounts of the Internet Café servers.

The preferred embodiments of the present invention have been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

Industrial Applicability

According to the present invention, the Internet Café rental fee is differentially imposed to each gamer depending on win/loser of the game, which promotes more persons to join the game and use the Internet Café.

If joining the game is activated, on-line game industry can be developed at the request for diversification of game software, thus makes it possible to create benefit models.

In addition, participants in the game can be improved in quality since the gamers show good faith to the game. Furthermore, because the game can be smoothly progressed in earnest, the gamers will not prolong the game or conduct unnecessary activity during game, thus solving the bottleneck phenomenon on network.

What is claimed is:

1. A method of exact calculation of gambling game fee under the network environment in which a plurality of gamer terminals are connected through a local network to a first server computer, a plurality of the first server computers are connected to a second server computer, and the second server computer is connected to a banking computer, which possesses actual accounts of service providers managing the local network and is capable of transferring money between the actual accounts on-line, the method comprising the steps of:
(a) opening actual accounts of a plurality of the service providers with the banking server and creating a virtual account corresponding to the actual account with the second server computer;
(b) at least two gamer inputting requests for gambling at a specific game into the second server computer;
(c) allowing at least two gamers to compete each other in the specific game, deciding winner and loser of the game when the game ends, and then calculating a game fee based on hours that the game has proceeded;
(d) drawing money corresponding to the game fee from a virtual account of a service provider of the local network used by the winner and then transferring the money to a virtual account of a service provider of the local network used by the loser;
(e) investigating the balances of all virtual accounts when it comes to the time of settlement to calculate money transfer details corresponding to each actual account; and
(f) instructing the banking computer to transfer money between the actual accounts based on the money transfer details.

2. A method of exact calculation of gambling game fee according to claim 1, further comprising the step of checking the service provider of the local network used by the gamer and the virtual account of the corresponding service provider on the basis of location information of the gamer terminal requesting the gambling game.

3. A method of exact calculation of gambling game fee according to claim 2, further comprising the steps of:
transmitting game win/lose information, proceeded game hour information and game fee information to the first server of the local network used by the winner and the loser; and
calculating rental fees of the local network and each gamer terminal belonging to the local network on the basis of the game win/lose information, the proceeded game hour information and the game fee information.

4. A method of exact calculation of gambling game fee according to claim 3,
wherein a total fee of the winner is calculated by subtracting the game fee from the rental fee, while a final fee of the loser is calculated by adding the game fee to the rental fee.

5. A method of exact calculation of gambling game fee according to claim 1,
wherein the virtual account initially has a zero balance,
wherein the balance becomes minus when money is transferred to another virtual account, and
wherein the balance is reset to zero after the time of settlement.

6. A method of exact calculation of gambling game fee according to claim 5, in the (vi) step,
wherein the money transfer details of the actual account are created based on the virtual account,
thereby, if the balance of the virtual account is plus at the time of settlement, instructing the back computer to draw an amount of money, equal to the plus amount, from the corresponding actual account to be distributably transferred to at least one other actual account,
or, if the balance of the virtual account is minus at the time of settlement, instructing the bank computer to distributably draw an amount of money, equal to the minus amount, from at least one other actual account to be received to the corresponding actual account.

7. A method of exact calculation of gambling game fee according to claim 1, further comprising the steps of:
searching the balances of the actual accounts for all service providers in the banking computer;
comparing the searched balances with a standard balance; and
outputting an electronic notification note for notifying the server computer of the service provider, whose the actual account has a balance less than the standard balance, to deposit money as much as the difference with the standard balance in the actual account.

8. A method of exact calculation of gambling game fee according to claim 7, further comprising the steps of:
extracting an actual account having a balance less than the standard balance after a term of the electronic notification note; and
interrupting the gambling game service of a gamer terminal connected to a local network of the service provider corresponding the extracted account.

9. A method of exact calculation of gambling game fee according to claim 6,
wherein the actual account is capable of having minus balance up to a predetermined limit.

12. An apparatus for arranging a gambling game between at least two gamer and settling gambling game fees depending on win or lose of the gambling game under the network environment in which a plurality of gamer terminals are connected through a local network to a first server computer, a plurality of the first server computers are connected to a second server computer, and the second server computer is connected to a banking computer, which possesses actual accounts of service providers managing the local network and is capable of transferring money between the actual accounts on-line, the apparatus comprising:
a storage unit; and
a processing unit connected to the storage unit,
wherein the storage unit stores program to control the processing unit, and
wherein the processing unit performs:
creating a virtual account corresponding to each actual account of a plurality of service providers opened with the banking server;
receiving requests for gambling at a specific game from at least two gamer;
allowing at least two garners to compete each other in the specific game, deciding winner and loser of the game when the game ends, and then calculating a game fee based on hours that the game has progressed;
drawing money corresponding to the game fee from a virtual account of a service provider of the local network used by the winner and then transferring the money to a virtual account of a service provider of the local network used by the loser;
investigating the balances of all virtual accounts when it comes to the time of settlement to calculate money transfer details corresponding to each actual account; and
instructing the banking computer to transfer money between the actual accounts based on the money transfer details.

11. An apparatus according to claim 10,
wherein the processing unit checks the service provider of the local network used by the gamer and the virtual account of the corresponding service provider on the basis of location information of the gamer terminal requesting the gambling game.

12. An apparatus according to claim 11, wherein the processing unit:
transmits game win/lose information, proceeded game hour information and game fee information to the first server of the local network used by the winner and the loser; and
calculates rental fees of the local network and each gamer terminal belonging to the local network on the basis of the game win/lose information, the proceeded game hour information and the game fee information.

13. An apparatus according to claim 10, wherein the processing unit:
if the balance of the virtual account is plus at the time of settlement, instructs the back computer to draw an amount of money, equal to the plus amount, from the corresponding actual account to be distributably transferred to at least one other actual account,
or, if the balance of the virtual account is minus at the time of settlement, instructs the bank computer to distributably draw an amount of money, equal to the minus amount, from at least one other actual account to be received to the corresponding actual account.
